(19) United States
(12) Patent Application Publication
(10) Pub. No.: US 2019/0213518 A1
(43) Pub. Date: Jul. 11, 2019

(54) Collaborative and dynamic mobile workflow execution platform

(71) Applicants: Francis Lee, Jacksonville, FL (US); Hamid Moutawakkil, Montigny-les-Cormeilles (FR)

(72) Inventors: Francis Lee, Jacksonville, FL (US); Hamid Moutawakkil, Montigny-les-Cormeilles (FR)

(21) Appl. No.: 15/732,071

(22) Filed: Sep. 13, 2017

Related U.S. Application Data
(60) Provisional application No. 62/385,614, filed on Sep. 9, 2016.

(51) Int. Cl. G06Q 10/06; G06Q 20/32; G06Q 20/06; G06Q 20/38

(52) U.S. Cl. CPC G06Q 10/06316; G06Q 20/389; G06Q 20/0658; G06Q 20/322

(57) ABSTRACT

This invention is a fully functional workflow platform or middleware on a mobile device that is able to create, modify and execute its own workflows and synchronize with external services on the mobile device or on a remote back-end such as a server using asynchronous and/or synchronous communications. This invention also includes a back-end computing platform that integrates with the mobile device and with a blockchain.

### RELATED APPLICATIONS

The present nonprovisional patent application claims the benefit of the filing date under 35 U.S.C. § 119(e) of Provisional Patent Application Ser. No. 62/385,614 filed on Sep. 9, 2016.

### BACKGROUND OF THE INVENTION

### A. Field of the Invention

The present invention relates to a mechanism for workflow execution and business process execution or a method for business process execution on a mobile electronic device that may operate autonomously. The invention also includes a back-end computing platform that integrates with the mobile device and with a blockchain. The invention uses the blockchain to license usage of the platform, store workflow execution information and to trade platform configurations for individual industries/vertical markets, workflow templates (“X_WFT”s) and utilities that support the workflow platform.

### B. Prior Art

There are many other prior art references to workflows and business process applications using networks.

A representative example of this can be found in Flores U.S. Pat. No. 5,734,837 which is a method and apparatus for building a business process application in terms of its workflow.

Another representative example can be found at Rachamadugu U.S. Pat. No. 9,076,311 which is a method and apparatus for providing remote workflow management. Yet another example that can be found in the prior art can be found at Peed US Publication 2014 0229227. Peed teaches a business process workflow system.

However, while these particular applications which are representative examples of items in the prior art, none of them incorporate the various features that are round in this particular application.

This particular invention allows multiple users and organizations to create, interact with, receive information from and change workflows on a mobile device and for the mobile device to change its own workflow to increase efficiency and productivity.

This invention utilizes smart contracts on the blockchain and a Licensing Token to provide licensing rights to users of workflows and features provided by the back-end computing platform and by the mobile device. The back-end computing platform may be used to create new platform configurations, new workflow templates and workflows for execution on the mobile device or on the back-end platform. The blockchain (or other electronic vault) is used to record the ownership of platform configurations for specific vertical markets, workflow templates, “X-Cards” and utilities, and to enable trading of these items using a Cryptocurrency token.

The blockchain is also used as a ledger to record the outcomes and events resulting from the execution of workflows, and to enable settlement of payments due before and after the execution of a workflow. It is used to enable the settlement of disputes.

### BRIEF SUMMARY OF THE INVENTION

The present invention provides a fully functional workflow platform or middleware on a mobile device that is able to create, modify and execute its own workflows and synchronize with external services on the mobile device or on a remote back-end such as a server using asynchronous and/or synchronous communications. The invention supports stand-alone or imported workflows on a mobile device with a rich feature set and interactions with the blockchain through a back-end computer server. The mobile device may be provided with the workflow that it has to execute by the back-end computer service. The mobile device is used as a fully-fledged computer to provide a unique and novel technology stack. The mobile device continues to process a workflow autonomously if it has no connection with external back-end services. The mobile device can be used as an extension of enterprise or back-end applications and workflows. The workflow can invoke third party applications or services, on the phone or mobile device and elsewhere, or third party applications, services or users on the phone or mobile device and elsewhere, can invoke a workflow. Also, the present invention allows for a workflow to invoke another workflow.

The platform enhances collaborative cooperation and communication by allowing multiple individuals or parties to communicate and collaborate in real-time, share, view, accept and change the progress of workflow and service execution—the process of carrying out tasks to complete a business process. When an individual, party, or the platform itself provides an update regarding a task, every other interested and permitted party can consume, observe or interact with the update. This platform also supports components that enable communication between multiple parties involved in the workflow.

Furthermore, the platform will monitor the execution of the business process and determine if the execution of the process can continue as planned. A “guard” or checking mechanism will be provided to insure that necessary preconditions in the workflow are met for a later activity to be executed.

The unique aspects of the present invention include the program providing dynamic modification of a workflow structure in real-time based on new information that is provided to the system by one or more parties, as allowed by a security and permissions framework related to the work being performed. The workflow may also require additional information from the relevant party or parties, so that it can update or complete its structure as needed.

During the execution of the workflow (a “job”), the mobile device creates “job events”. These job events are transmitted to authorized parties for processing (for example by using an API, text message, email, push notification or web service over any network such as GSM, Bluetooth or wi-fi). Job events may also be recorded on the blockchain. The complete history of each job, including the workflow that was executed, the order, contextual information, application events, workflow (“Job”) events and system events may also be stored on the blockchain and off the blockchain.

### BRIEF DESCRIPTION OF THE DRAWINGS

FIG. 1 is a schematic representation of the present invention that depicts various parties being able to collaborate and network on their mobile devices in order to execute a task or objective.

FIG. 2 depicts various layers of the mobile workflow platform.

FIG. 3 is a flowchart representation of a workflow model.

FIG. 4 is a flow chart representation of a workflow invocation.

FIG. 5 is a schematic representation of a workflow model being described by a representative workflow definition.

FIG. 6 is a schematic representation of a how a workflow may be created.

FIG. 7 is a schematic representation of a synchronous activity execution model.

FIG. 8 is a schematic representation of an asynchronous activity execution model.

FIG. 9 is a schematic representation of a context manager.

FIG. 10 is a schematic representation of a repository.

FIG. 11 is a schematic representation of script execution.

FIG. 12 is a schematic representation of an expression evaluator.

FIG. 13 is a schematic representation of an event manager.

FIG. 14 is a schematic representation of processors defined in the mobile device platform.

FIG. 15 is a schematic representation of two workflow processors.

FIG. 16 is a schematic representation of a flow processors.

FIG. 17 is a schematic representation of a sequence processor.

FIG. 18 is a schematic representation of a sequence state management.

FIG. 19 is a schematic representation of the interaction between the invention and the blockchain.

FIG. 20 is a schematic representation of how an job event is recorded on and off the blockchain and retrieved from the blockchain.

FIG. 21 is a schematic representation of how licensing for usage of the invention is supported by the blockchain.

FIG. 22 is a schematic of how workflow templates, business configurations, and utilities including mobile “X-Cards” and “X-Order Translators” are traded in a marketplace.

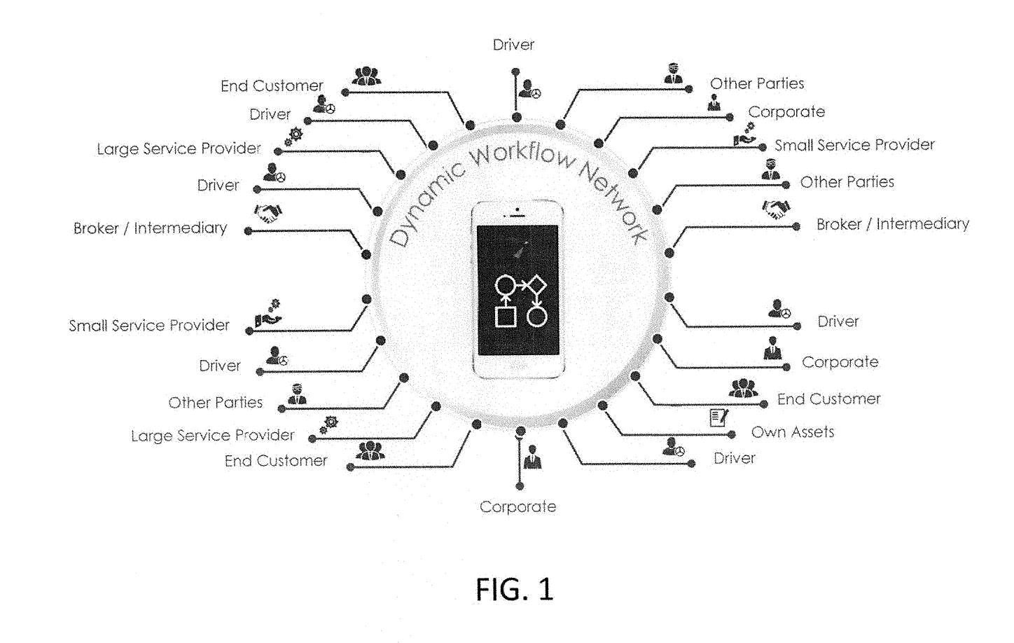

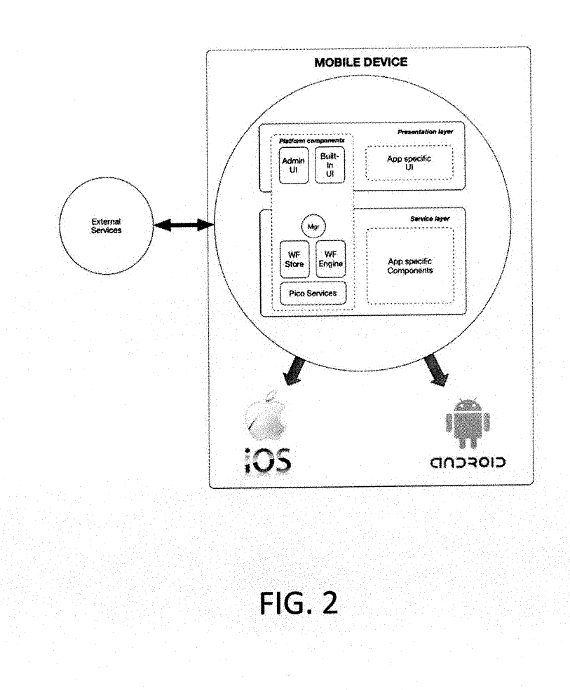

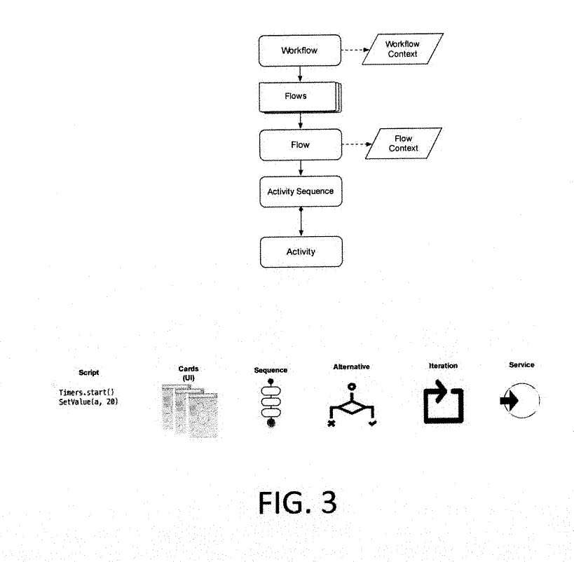

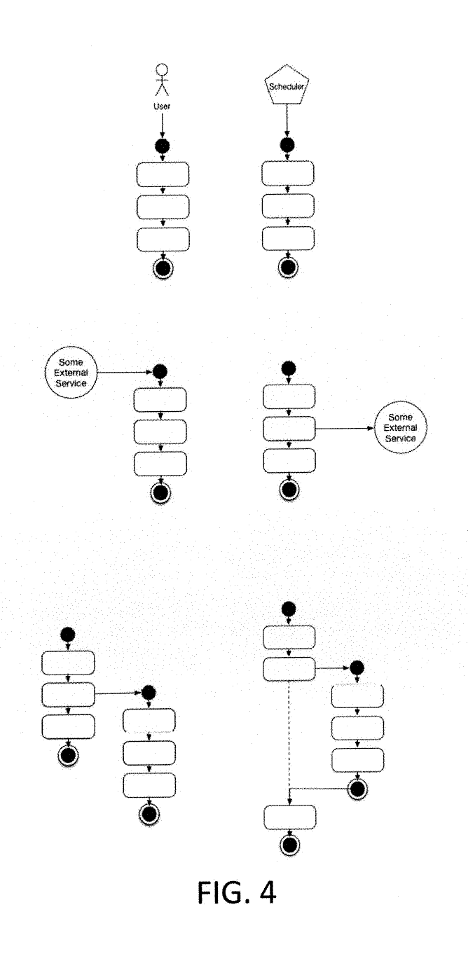

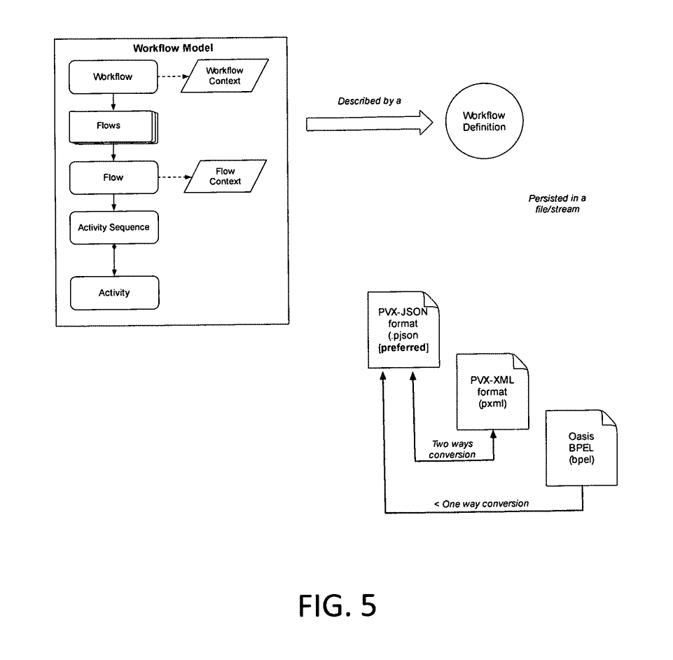

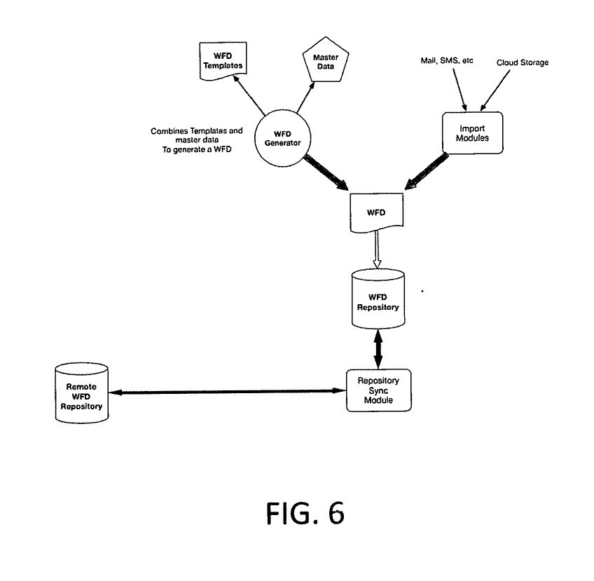

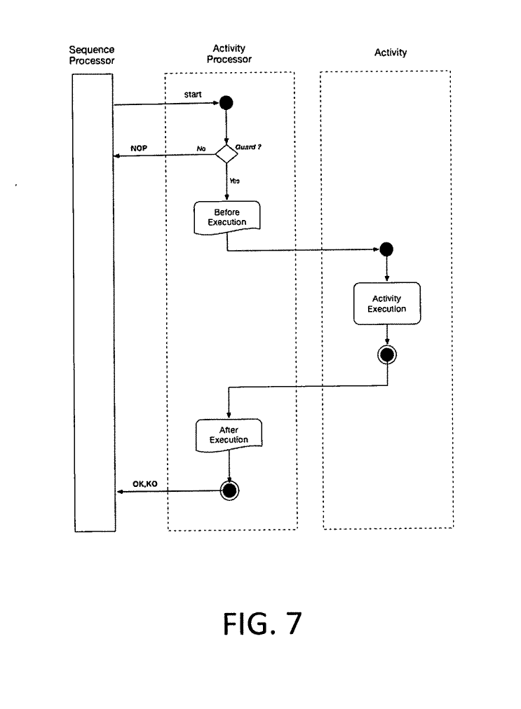

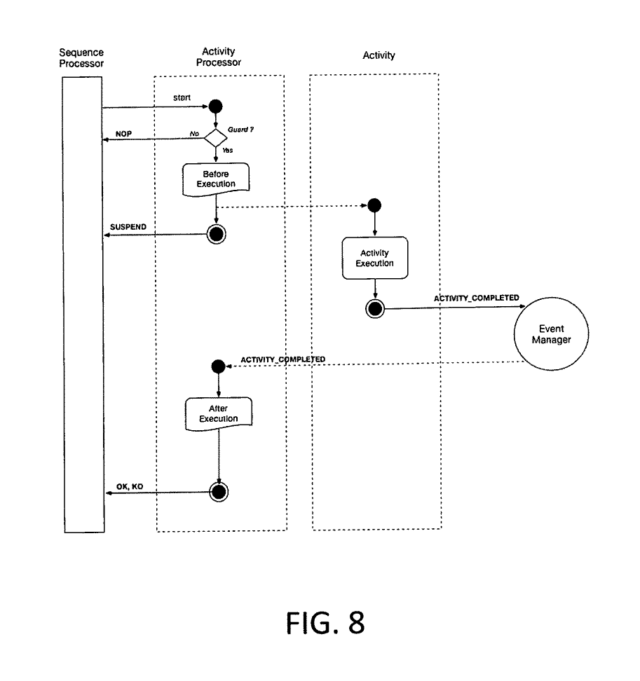

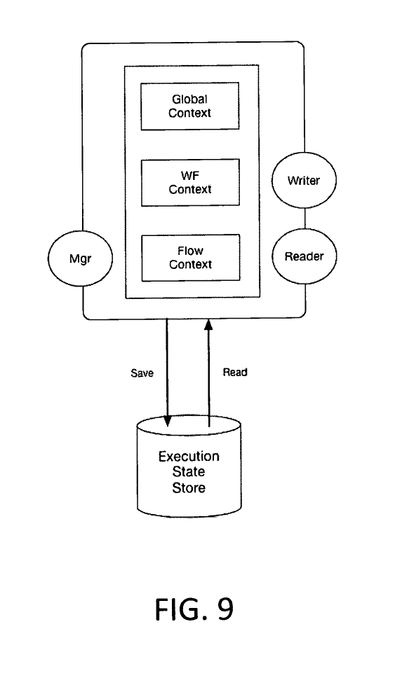

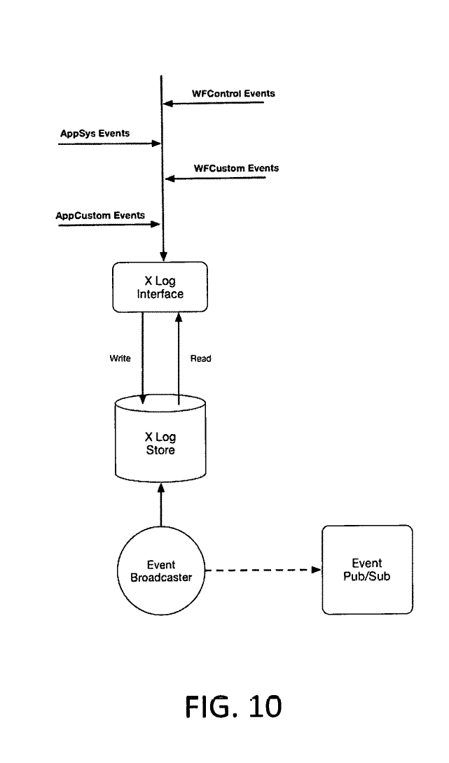

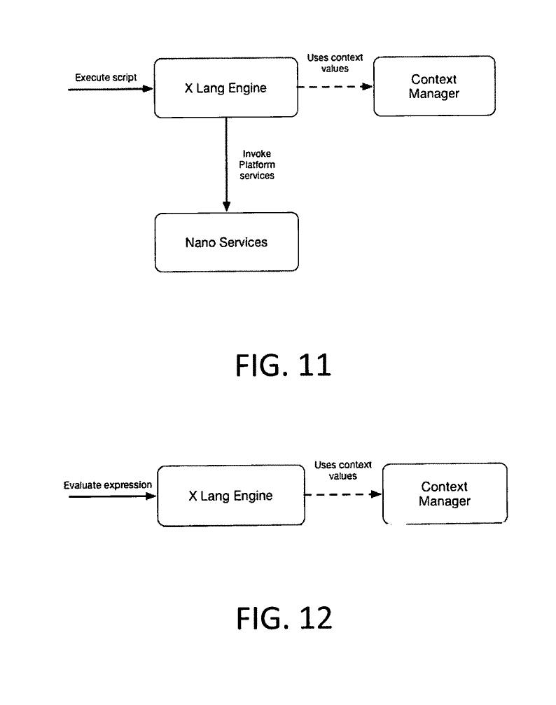

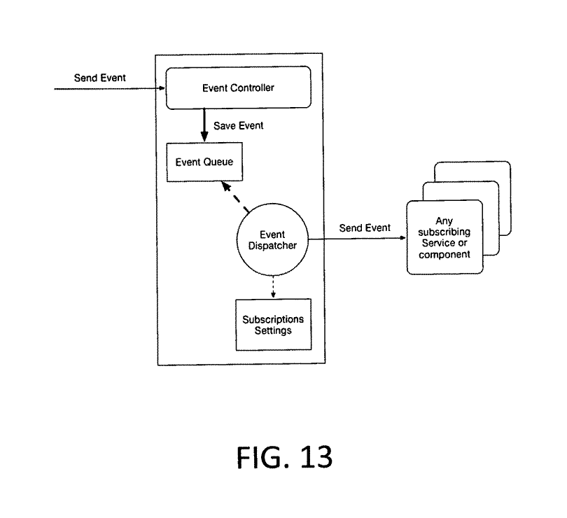

### DETAILED DESCRIPTION OF THE EMBODIMENTS

The present invention is a software platform or middleware that is to be provided on mobile devices, on a back-end computer system and on the blockchain for remote access computing in the delivery and execution of mobile services requiring efficient coordination and collaboration between multiple parties and workflow efficiency. This software platform can be particularly useful in the transportation industry, for the on-demand services industry, and many others. In essence this is for a software platform that is designed to support individuals and businesses of any size and enable them to effectively compete as well as collaborate.

For example, in the transportation industry, the present invention can support the self interests of all players, such as the consumers, the brokers, the carriers, ports, consignees, and others. With regard to trucking, the present invention can allow a small trucking company to work directly from major shippers or brokers. With regard to creation and operation of a transportation network, the present invention allows for the design and execution of a load-specific workflow that provides realtime visibility and control over load execution to all permitted parties for that load. The template of workflow used for a specific load may be pre-agreed between the parties and may include workflow elements specific to each location involved in the execution of the load. The invention also allows for certain access rights and responsibilities to be designated to certain individuals and for a plurality of individuals to effectively collaborate and accomplish a task within the workflow and for separate workflows to be created in such a way that they may interact with each other. For example the driver of the vehicle responsible for executing a workflow for the delivery of a load and the person responsible for receiving the load may both execute workflows, with the completion of the delivery only being confirmed when both the driver and the receiver have n=both completed their respective confirmations.

In the on-demand services industry the present invention has a broad application. For example, the invention can be utilized by the following, but not limited to, food delivery men and women, couriers and messengers, roofers, electricians, cab drivers, nurses, dog walkers, home caters, homecare services such as yard services and pool cleaning, and handy-man services to name a few. This invention allows private businesses to be protected from and compete effectively with large companies in the use of “on demand” disruptive technologies.

The platform allows for the ability to run a full business process/workflow on a mobile device. It provides a workflow engine on a mobile platform and treats a mobile electronic device like a full back-end server. The workflow can be either standalone on the mobile device or part of a broader orchestration such as a higher level process on a back-end computer system. Compute intensive processes can be delegated, by configuration or on-demand, to a back-end computer system. For example, generation of workflow definitions, navigation, estimated times of arrival, interactions with the blockchain etc.

This is an application which can effectively increase the efficiency and reduce the cost of executing a business process through using a mobile electronic device. The mobile electronic device will enable connection and sharing of process execution information between a customer and the service provider responsible for the delivery of any mobile service and any other parties with an interest in that service. It will also allow the service provider as well as the customer to interact with a broker or intermediary if the broker has arranged for the services to be provided by the service provider to the customer. The platform enables appropriate delivery instructions to be delivered to the service provider (such as a the driver of a truck) and for appropriate changes to those instructions to be conveyed to the service provider at a given time. This system allows the flexibility to change a workflow process while it is being executed that is not found in traditional workflow processes.

A workflow is comprised of a business process executed using a workflow definition (“X-WFD”), Scripts in a scripting language (“X-Script”), “nano services” (services provided on the mobile device—the equivalent of micro services on a back-end server) and “X-Cards” that define the user interface on the mobile mobile device and the system's interactions with external services and applications on the device. The workflow definitions are generated from master data such as any combination of contract, orders, parameters, settings, etc. and a workflow template (“X-WFT”) or by direct implementation using X-Script.

Workflow definitions can be sent or imported to the mobile device through different channels like emails, SMS, or any chatting tools that supports the sharing of documents. Cloud Storage can also be used to retrieve a X-WFD. X-WFDs may be obtained from multiple sources through multiple channels (as well as being generated on the mobile device).

Workflow definitions may also be generated on the mobile device, or by an external service. A generation engine, also known as the X-Order Translator, workflow generator or X-WFD generator, is used to create a new workflow definitions from templates and Master Data. Master Data is data that the generator uses to drive the generation. For example, Master Data might include a job or an order and the settings and parameters that are used to guide the generation process. The X-WFD generator/X Order Translator may sit on the mobile device or on another external platform.

Workflow templates can be imported the same way the workflow definitions are. Master Data can be either retrieved from a web API or created by capture on the device, through different user interfaces.

The present invention is also capable of supporting imported workflow definitions defined in other business process languages such as BPEL. The mobile workflows are (Meta) dynamic in that the very structure of the mobile workflow can be adjusted by multiple parties external to the mobile workflow and the mobile workflow may replace itself by a new structure. Mobile workflows can create new mobile workflows—the conditions of a workflow's satisfaction can be completely changed during the execution of that workflow.

A commercial repository of workflow templates (“X-WFTs”) for specific job types, as supported by the workflow platform, may be purchased or obtained from a Store in a similar manner to Mobile Apps being purchased from an application store. In other words, it is anticipated that a user can purchase or license a job type or mobile workflow template (X-WFT or X-WFD) from a workflow store and then import the workflow template or definition onto the mobile device.

Multiple parties may participate create, observe, update, change, terminate, roll-back, etc. a mobile workflow with roles being defined by a permission structure that is specific to the job being executed. In some scenarios it is possible to maintain a master workflow definition repository on a back-end service. In these cases, the Repository Synchronization Module, will ensure that workflow definitions added to the remote repository are made available on the mobile device's local repository.

A runtime framework on the phone or mobile device provides a set of “nano services” that can be invoked through the X-Script scripting language. One X-Script can work on multiple phone or mobile device operating systems (e.g. Android, IOS or Windows). The present invention's workflow engine itself is accessible as a nano service through a customized X-Script script.

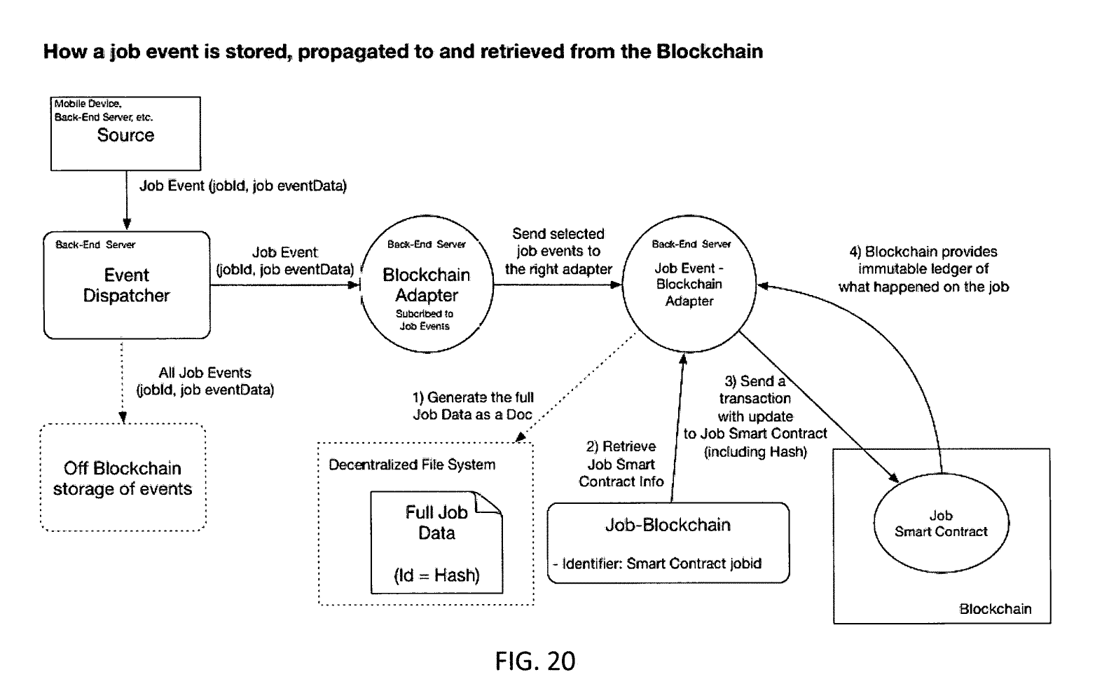

The workflow log includes “job events” consisting of application events, workflow events and system events. The workflow log is capable of being synchronized with any third party repository through synchronization end points provided on the phone or mobile device as part of the platform. Job events may be recorded on the blockchain and off the block-chain by back-end services. Job events may also be transmitted to interested/permitted parties. A complete encrypted log of each job may also be stored on or off the blockchain. (See FIG. 20).

The present inventive workflow platform supports custom screens (X-Cards), scripts sequences (X-Scripts), a complex workflow flow execution control logic, and a wide variety of accesses to external services. An X-Card is a defined user interface or functionality that is created independently of the workflow. An X-Script is anticipated to have access to all the nano services and to the workflow engine, including creation of a new workflow. It can also update master and context data.

A Context Manager on the mobile device is used to store different execution contexts, containing “context values” that can be used within the workflow for processing. The Context Manager service functions are used to add or remove a context from the context manager and create a hierarchy of contexts. The reader service is used to resolve any context value requested, by inspecting the hierarchy of contexts. The writer service is used to write a context value in the dedicated context, either global or current, the current being the last context added. An Execution State Store is used to store all execution related data such as the sequence state, activity states and the Context for recovery, back-up, restart and workflow reversal. The Context Manager is the unique source for parameterized context values. It is a dynamic database for the workflow.

Event handlers for “before”, “after” and “undo” for X-Cards are all handled by X-script. To extends X-Cards technology, event handlers slots are added to support any X-Scripts. The ability to “Undo” steps in the workflow is provided in order to undo activities that have been completed. The depth of the “undo” steps are defined by configuration.

The workflow can invoke third party applications, on the phone or mobile device and elsewhere, or third party applications or users, on the phone or mobile device and elsewhere, can invoke a workflow. Also, the present invention allows for a workflow to invoke another workflow. The inventive platform additionally allows for a mobile workflow to pause while it waits for instructions from a third party (e.g. as may be needed to await information being delivered to the phone or mobile device for processing, or awaiting to instructions as to how the workflow should now change or proceed). A workflow may change as a result of a receiving message from another service, application or user and it may also be changed by an X-Script script.

The mobile platform supports multi-channel and multi-method, (asynchronous and synchronous) communications with multiple end points such as back-end servers or document servers. These channels may be whitelisted.

With this particular application multiple users and parties will be able to interact with other users and parties and be able to change remote mobile workflows and thereby increase efficiencies and decrease costs.

Within the repository is a log that stores all the events generated by the mobile applications and by the workflow execution. The log is anticipated to support four types of events:
1. App System Events: These are all the possible predefined events generated by the application internals. Traces fall under this category.
2. X-WFD Custom Events: These are custom events defined by configuration. These events are customizable on a per X-WFT basis.
3. Workflow Control Events: These events are predefined events used by the workflow engine to control the workflow execution.
4. Workflow Custom Events: These are events defined by the configuration and emitted by activities of the workflow. Events stored in the log store can be broadcasted through the event dispatcher module. A single log file keeps a record of all the types of events listed above.

The event manager is the module that receives and dispatches messages to predefined recipients. It is an asynchronous dispatch engine which uses multiple channels, subject to highly configurable settings. Subscribing services or components can be either: other modules inside the application; other applications on the mobile device through application interoperability mechanisms; or online APIs such as REST web services. Users and parties may also subscribe to events through the use of other messaging platforms that are better suited for human understanding like a web application, text message, chat service or email. External applications and users on the phone or mobile device and elsewhere can subscribe to events through the event manager.

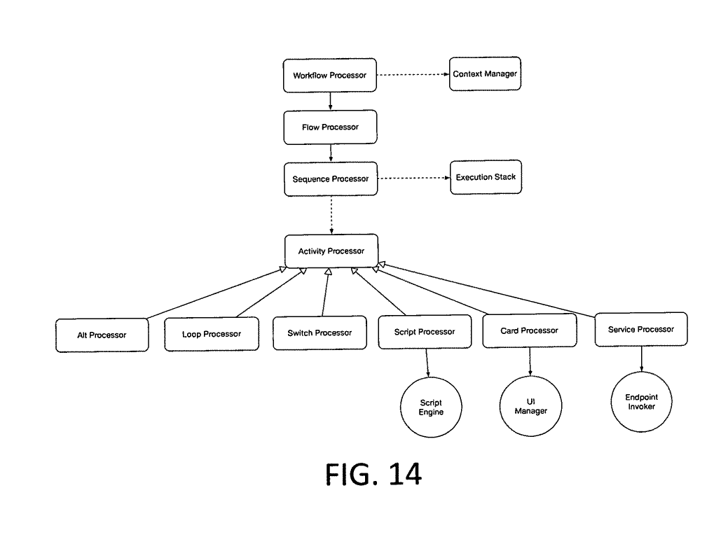

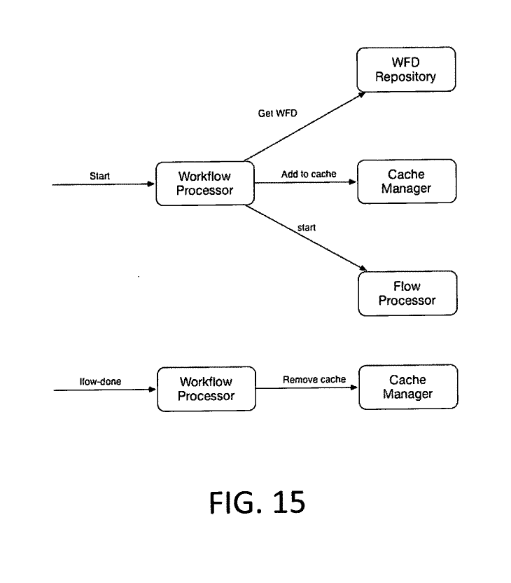

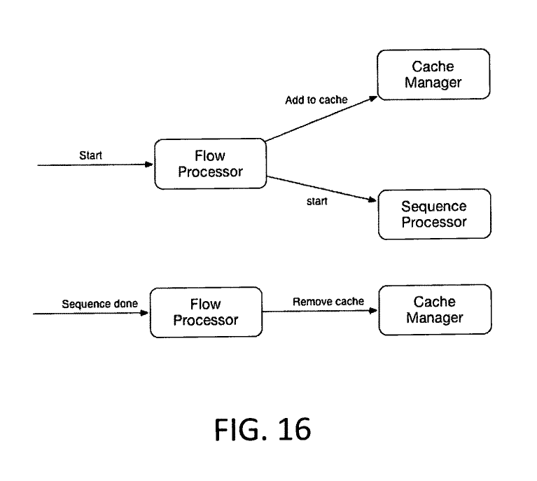

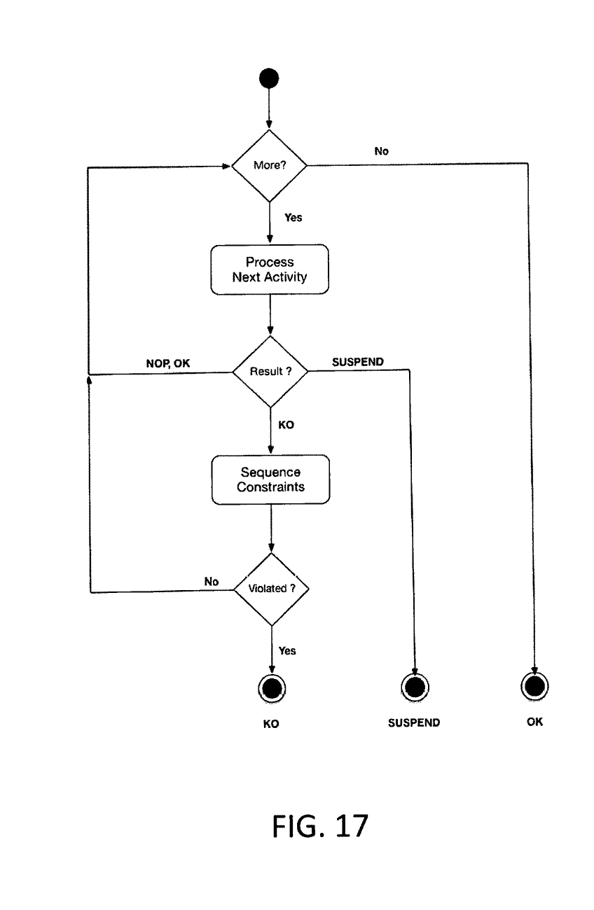

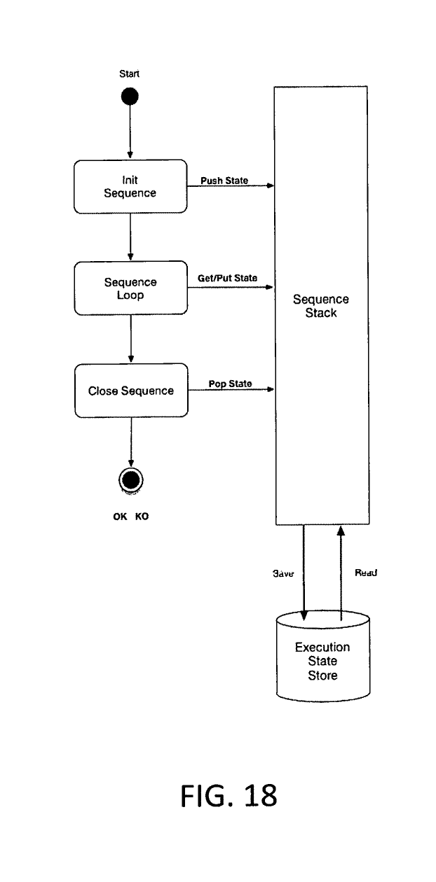

Processing components are shown in FIG. 14. When a workflow is required to be started, it retrieves the workflow definition (X-WFD) and initializes the execution. It creates a cache entry and adds it to the cache manager. Next, the Flow processor is started to execute the main flow of the workflow. Once the main flow is complete, the message “flow-done” appears. It allows the workflow processor to clear the cache manager.

Starting a flow will push its cache setting into the cache manager, and starts its sequence of activities. Once the sequence of activities is done, the flow processor will be able to clean the cache.

A sequence processor provides a logic algorithm for the sequence of execution, which includes executing an ordered list of activities, providing constraints with regard to what activities must be completed, and if an activity is not completed, the sequence will end with the result “KO”.

A sequence state management mechanism is provided, which is comprised of sequence stack component. The sequence stack component will store the current activity for each nested sequence. Each started sequence, will push its state into the sequence stack. When the sequence ends, it pops its state from the sequence stack. The sequence stack is stored into the execution state store. This insures that each nested sequence will have its state preserved. The sequence state holds the current Activity processed.

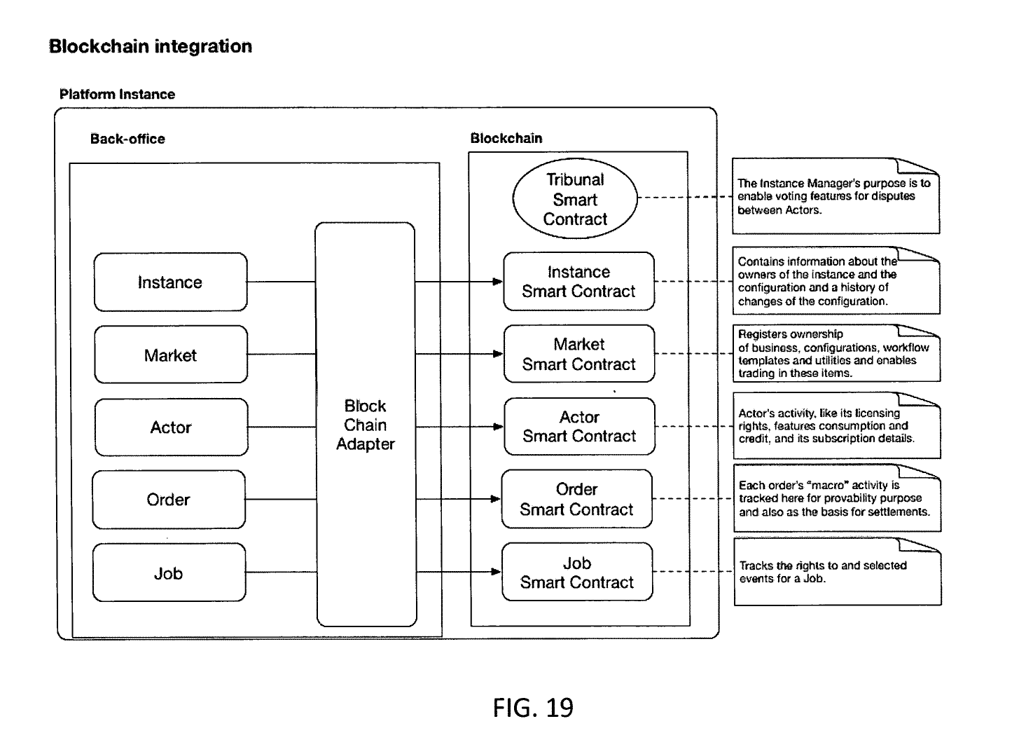

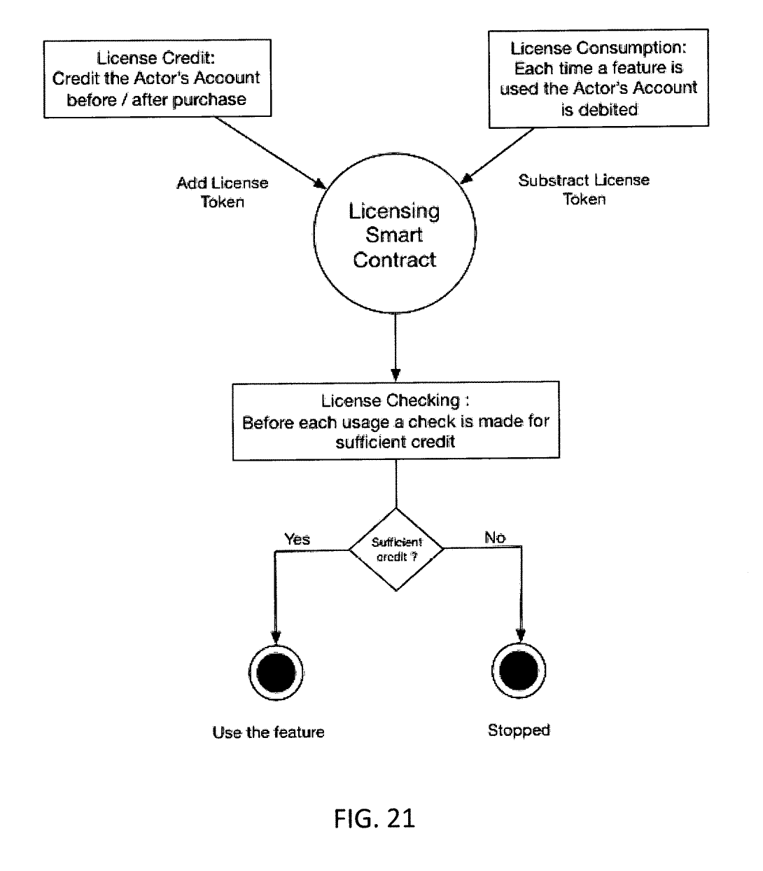

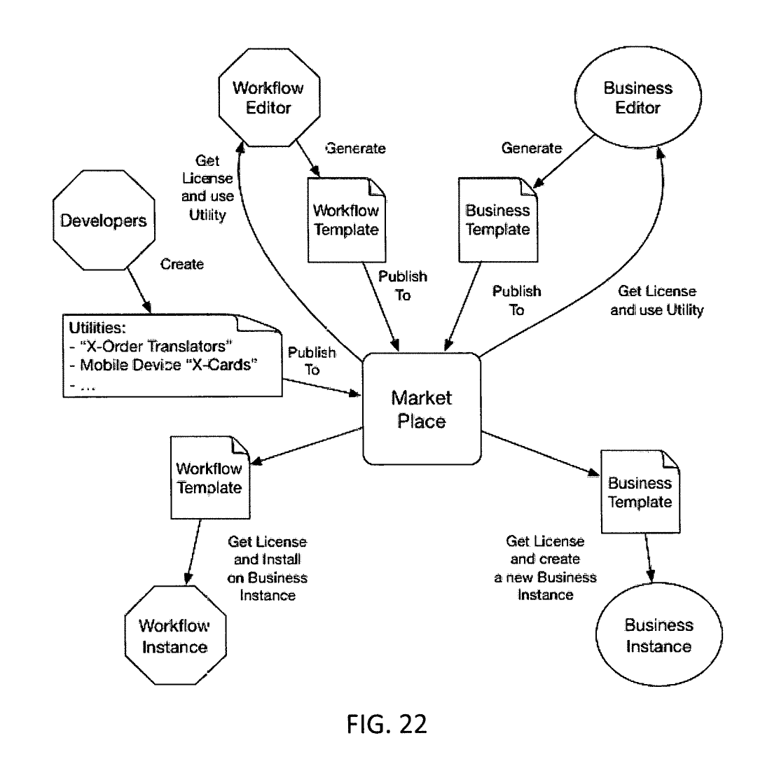

The system described by this invention may have comprehensive integration with the blockchain through a set of of smart contracts (see FIG. 19). Job Events (including workflow events, system events and application events) may be stored and retrieved using the blockchain as an imutable ledger (see FIG. 20). Access to any feature of the invention may be governed by a Licensing Smart Contract (see FIG. 21). A marketplace that registers the ownership of business configurations, workflow templates, x-cards, x-wfd generators and utilities and enables licensing of these items and trading in these items may be supported by the blockchain. (see FIG. 22).

1. A mobile workflow execution platform which is comprised of:
a. a workflow definition;
wherein the workflow definition can be generated from master data and a workflow template by a workflow generator;
wherein the master data is data that includes an order, settings and parameters;
wherein the order, settings, and parameters guide the workflow generator;
wherein the workflow definition can be shared to a mobile device through different communication channels or generated on a mobile device;
wherein the workflow definition has a permission structure specific to the workflow definition and the job being executed that defines multiple parties rights with respect to the workflow;
b. a scripting language;
where the workflow definition is encapsulated in a program written in a scripting language;
c. nano services;
wherein the services provided natively by the mobile device can be invoked through the scripting language;
d. x-cards
wherein the user interface on the mobile device and the system's interactions with external services and applications on the device may be defined;
e. a workflow log;
wherein the workflow log tracks workflow job events and includes workflow events, application events and system events;
wherein the workflow log can be synchronized with any third party repository;
wherein the workflow log, or selected events from the workflow log, may be stored on the blockchain
f. a workflow engine on the mobile device;
wherein the workflow engine processes the workflow definition;
wherein the workflow engine provides access to the nano services and x-cards;
wherein the workflow engine provides access to communications between the mobile device and other electronic devices;
wherein multiple-parties can communicate with the workflow engine on the mobile device and change the workflow definition during its execution, as permitted by a security framework that is unique to that workflow definition;
wherein the workflow engine may change the workflow definition during its execution;
wherein the workflow engine on the mobile device continues to execute the workflow definition autonomously when there are no communications available to other electronic devices;
wherein the workflow engine communicates with other electronic devices by sending job events, system events and application events asynchronously when communications are available to other electronic devices.

2. The mobile workflow execution platform as described in claim 1 wherein a commercial repository and marketplace of of business configurations, workflow templates, X-Cards and utilities that may be used by the workflow engine is provided.

3. The mobile workflow execution platform as described in claim 1 wherein the mobile workflow platform is integrated with the blockchain.

4. The mobile workflow execution platform as described in claim 3 wherein the workflow job events can be recorded on the blockchain.

5. The mobile workflow execution platform as described in claim 1 wherein a blockchain enabled marketplace is provided.

6. The mobile workflow execution platform as described in claim 5 wherein the blockchain is used to record the ownership of business configurations, x-wfd/workflow generators, workflow templates, x-cards and utilities that may be used by the workflow engine;

7. The mobile workflow execution platform as described in claim 1 wherein a cryptocurrency token is provided.

8. The mobile workflow execution platform as described in claim 7 wherein the cryptocurrency token enables the purchase and sale of business configurations, x-wfd/workflow generators, workflow templates, x-cards and utilities that may be used by the workflow engine and that are stored on the blockchain.

9. The mobile workflow execution platform as described in claim 1 wherein feature licensing is provided.

10. The mobile workflow execution platform as described in claim 9 wherein the system uses the blockchain to manage each party's licensing rights to access features of the platform.

11. The mobile workflow execution platform as described in claim 9 wherein workflow definition licensing is provided.

12. The mobile workflow execution platform as described in claim 11 wherein the system uses the blockchain to manage each party's rights of access to a each unique workflow definition's execution.
